(19) United States
(12) Patent Application Publication
(10) Pub. No.: US 2010/0042514 A1
(43) Pub. Date: Feb. 18, 2010

(54) METHOD AND SYSTEM FOR VERIFIABLE ALLOCATION OF AN ENVIRONMENTAL RESOURCE PRODUCT TO AN ENVIRONMENTAL RESOURCE

(76) Inventor: Rutherford Peter Bruce Browne, Bellingham, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/537,996

(22) Filed: Aug. 7, 2009

Related U.S. Application Data
(60) Provisional application No. 61/089,807, filed on Aug. 18, 2008.

(51) Int. Cl. G06Q 10/00; G06F 17/30; G06F 7/10; G06Q 30/00; G06Q 40/00; G06F 15/16

(52) U.S. Cl. 705/27; 707/3; 705/44; 705/26; 705/1; 707/E17.108; 709/203; 707/104.1; 707/E17.044

(57) ABSTRACT

A method of verifiable allocation of a purchased environmental resource product (ERP) to an environmental resource may include: receiving at a central server a transaction code request from an ERP vendor, the transaction code request specifying at least one ERP identifier of a respective at least one ERP that is the subject of a purchase transaction, the central server having access to public data regarding the environmental resource; determining whether the transaction code request is valid; generating a unique transaction code in response to the transaction code request if the transaction code request is determined to be valid; recording the purchase of the at least one ERP; and making publicly accessible a representation of the environmental resource having purchase status information corresponding to the purchased at least one ERP viewable in relation to the representation.

### CROSS-REFERENCE TO RELATED APPLICATIONS

This application claims the benefit under 35 U.S.C. 119(e) of U.S. Provisional Application Ser. No. 61/089,807, filed 18 Aug. 2008, the entire contents of which is hereby incorporated by reference.

### TECHNICAL FIELD

The described embodiments relate to computerized methods and systems for verifiable allocation of an environmental resource product (ERP) to an environmental resource.

### BACKGROUND

In recent times, there has been an increasing public awareness of the need for preservation of the earth's environment and ecosystems, as well as the need to reduce or mitigate the possible detrimental effect that members of the public may have as consumers upon the earth's environment and ecosystems. Consequently, there is a growing segment of the public and a growing number of businesses that seek to offset any impact of their consumer or business activities on the environment and/or are interested in protecting and/or restoring environmental resources or creating new environmental resources.

Some businesses now make available environmental resource products (ERPs) relating to one or more specific environmental resources for public purchase. Such environmental resource products may involve environmental mitigation, restoration, conservation and/or carbon offset products, for example. Some such ERPs may be subject to abuse by sale of the same ERP to multiple purchasers, without any way for such purchasers to verify that each purchase relates to a unique ERP.

It is desired to address or ameliorate one or more shortcomings associated with existing ERP transactions, or to at least provide a useful alternative thereto.

### SUMMARY

Some embodiments relate to a method of verifiable allocation of a purchased environmental resource product (ERP) to an environmental resource. The method comprises: identifying a purchase transaction for at least one ERP; determining at least one unique ERP identifier for the respective at least one ERP; transmitting a transaction code request for processing by a central server, the transaction code request specifying at least one ERP identifier, the central server having access to public data regarding the environmental resource; receiving a unique transaction code in response to the transaction code request; and providing notification of the unique transaction code and the at least one ERP identifier, the unique transaction code and the at least one ERP identifier being usable by a purchaser of the at least one ERP to verify at the central server the allocation of the at least one ERP to the environmental resource.

Further embodiments relate to an alternative method of verifiable allocation of a purchased environmental resource product (ERP) to an environmental resource. The method comprises receiving at a central server a transaction code request from an ERP vendor, the transaction code request specifying at least one ERP identifier of a respective at least one ERP that is the subject of a purchase transaction, the central server having access to public data regarding the environmental resource; determining whether the transaction code request is valid; generating a unique transaction code in response to the transaction code request if the transaction code request is determined to be valid; recording the purchase of the at least one ERP; and making publicly accessible a representation of the environmental resource having purchase status information corresponding to the purchased at least one ERP viewable in relation to the representation.

Some embodiments relate to a method comprising: offering for sale at least one environmental resource product (ERP) corresponding to an environmental resource; receiving a request to purchase the at least one ERP; initiating transmission of a transaction code request for processing by a server having access to public data regarding the environmental resource; receiving a unique transaction code generated in response to the transaction code request; and providing notification of the unique transaction code and an ERP identifier for each at least one ERP, the unique transaction code and the at least one ERP identifier being usable to verify at the server the allocation of the at least one ERP to the environmental resource.

Other embodiments relate to a method for generating environmental resource products (ERPs) based on a specific geographically located environmental resource. The method comprises: receiving a request to divide a bulk resource corresponding to the environmental resource into at least one ERP; validating the request; dividing the bulk resource into at least one distinct resource unit; allocating a unique identifier and a geographic location to each at least one resource unit; and transmitting a list of at least one ERP in response to the request, the at least one ERP corresponding to the respective at least one resource unit, the list comprising for each at least one ERP the unique identifier allocated to each at least one resource unit.

Other embodiments relate to a system for verifiable allocation of an environmental resource product (ERP) to an environmental resource. The system comprises at least one processing device having access to public data relating to the environmental resource and having access to an ERP database. The system further comprises computer readable storage storing program code executable by, and accessible to, the at least one processor. When executed by the at least one processor, the program code causes the at least one processor to: receive a transaction code request from an ERP vendor, the transaction code request specifying at least one ERP identifier of a respective at least one ERP that is the subject of a purchase transaction; determine whether the transaction code request is valid; generate a unique transaction code in response to the transaction code request if the transaction code request is determined to be valid; record the purchase of the at least one ERP in the ERP database; and make publicly accessible a representation of the environmental resource having purchase status information viewable in relation to the representation, the purchase status information corresponding to the purchased at least one ERP.

Still other embodiments relate to computer readable storage, storing program code which, when executed by at least one processor, causes the at least one processor to perform the methods described herein.

### BRIEF DESCRIPTION OF THE DRAWINGS

Embodiments are described below in further detail, by way of example, with reference to the accompanying drawings, in which:

FIG. 1 is a block diagram of a system for verifiable allocation of a purchased ERP to an environmental resource;

FIG. 2 is a block diagram of a central server system;

FIG. 3 is a flow chart of a method of generating environmental resource products from a bulk environmental resource;

FIG. 4 is a flowchart of a method of making environmental resource products available for purchase;

FIG. 5 is a flowchart of a method of tracking ERP purchases;

FIG. 6 is a flowchart of a method of validating a transaction code request; and

FIG. 7 is a block diagram of an example computing device.

### DETAILED DESCRIPTION

The described embodiments relate generally to computerized methods and systems for verifiable allocation of an environmental resource product (ERP) to an environmental resource. Some of the methods and systems may relate to processes performed at a central server system, while other methods and systems may be performed by or in relation to an ERP vendor that is in communication with the central server system. Embodiments also relate to computer readable storage storing computer program instructions (program code) executable by at least one processor for causing the at least one processor to perform any of the methods.

The described embodiments are generally directed to providing a paradigm under which transactions for purchase of ERPs can be audited and verified by purchasers of those ERPs as being uniquely owned. Under this paradigm, because of the auditable nature of the ERP transactions, ERP vendors gain improved credibility in the eyes of prospective purchasers of ERPs offered by that vendor, which in turn improves the viability of ERPs as saleable products. Where information on ownership of ERPs is publicly accessible, for example by providing the ownership data overlaid or mapped onto specific geographic location data, such as satellite imagery, ERP purchasers can get a real sense of their contribution to environmental conservation and/or restoration and can develop a portfolio of ERPs. Under such a paradigm, ERP ownership can effectively be tracked and recorded in a manner similar to land ownership.

References herein to an environmental resource product are intended to include products and/or services, whether tangible or intangible, provided in relation to a specific environmental resource having a fixed or unique geographical location. In this context, the term “environmental resource” is not intended to be limited to exploitable and/or consumable resources. Rather, such resources may be termed “environmental resources” by virtue of mere existence in an environmentally significant geographical location or by virtue of a function, for example, such as carbon dioxide (or other pollutant) sequestration or consumption and/or energy production arising from natural environmental conditions, such as wind, solar, geothermal, hydroelectric or other relatively passive forms of energy harvesting. Additionally, the term “environmental resource” may include renewable resources and/or underlying resources to sustain such renewable resources, for example such as a crop that can be used to produce energy efficient fuels and the land on which that crop is farmed.

An ERP may comprise a conservation easement or a right, such as a preservation, plantation or reforestation right or other chose in action, granted in respect of land to be used as a passive resource, for example where the land is forested and therefore consumes carbon dioxide. In another example, the ERP may carry with it rights, covenants or restrictions in relation to a more active resource, for example where the resource is farmed to produce energy efficient fuels. Alternatively, the environmental resource may be a non-land resource, such as a water-based resource, a sub-sea resource, an air-based resource or a subterranean resource.

Further, an ERP may comprise a quantum of energy produced by a wind-powered turbine in a specific location, for example. Purchasers of ERPs in the form of such an energy quantum can thereby effectively sponsor construction of a wind turbine or other non-traditional but environmentally low-impact energy source. An ERP may also take the form of a carbon offset associated with an underlying environmental resource having a fixed or unique geographical location. For example, the carbon offset may take the form of a conservation easement, right, covenant or other form of chose in action, in relation to preservation or reforestation of a specific area of land or in relation to other forms of carbon sequestration.

The above description of example ERPs is intended to be non-exclusive and non-limiting and is provided for purposes of illustration.

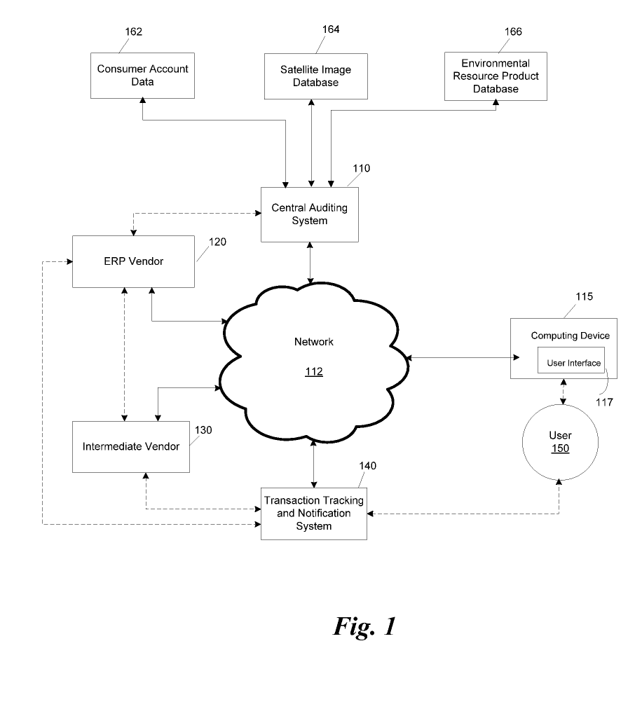

Referring now to FIG. 1, there is shown a block diagram of a system 100 for enabling verifiable allocation of an ERP to an environmental resource. System 100 comprises a central server system, termed for convenient reference herein as central auditing system (CAS) 110, a computer system 115 in communication with CAS 110 over a network 112 and an ERP vendor 120. System 100 may further comprise a transaction tracking and notification system 140 in communication with ERP vendor 120 and, in some embodiments, may comprise an intermediate vendor 130 in communication with ERP vendor 120 and transaction tracking and notification system 140 for facilitating ERP purchase transactions any or all of which may communicate with each other via network 112. System 100 further comprises a consumer account data repository 162, satellite image data 164 and an environmental resource product database 166.

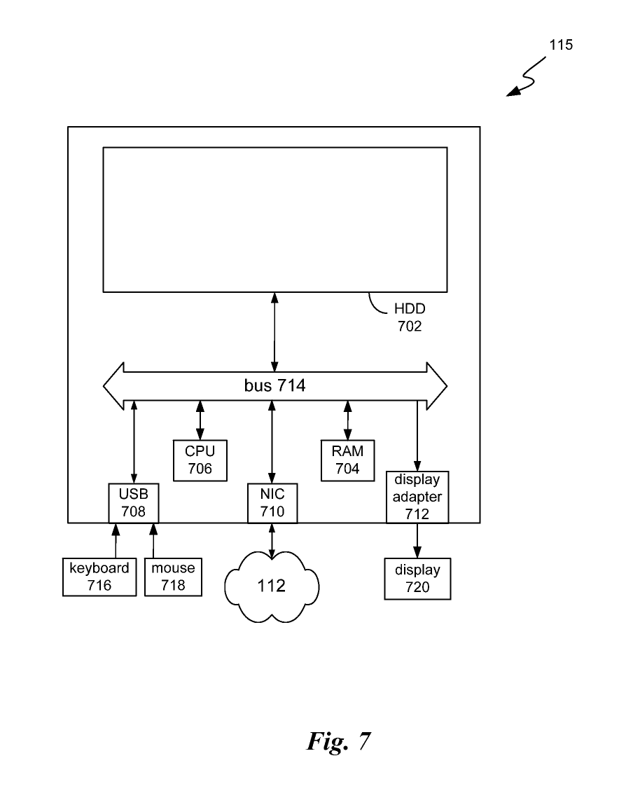

Computer system 115 may comprise a processor 706, a memory 702 (FIG. 7) and a user interface 117. Computer system 115 may comprise a personal computer, a server system or a combination of distributed computing devices, for example. User interface 117 comprises browser application software that may be used by user 150 in order to control computer system 115 to communicate with CAS 110 (or possibly the ERP vendor 120 or intermediate vendor 130) over network 112. Network 112 may be a public network, such as the Internet.

Computing device 115 may include standard computer components, as shown generically in FIG. 7, including random access memory (RAM) 704, at least one processor 706, and external interfaces 708, 710, 712, all interconnected by at least one bus 714. The external interfaces include universal serial bus (USB) interfaces 708, at least one of which is connected to a keyboard 716 and a navigation device, such as a mouse 718, a network interface connector (NIC) 710 which connects the computing device 115 to the communications network 112, and a display adapter 712, which is connected to a display device 720 such as an LCD panel display. Computing device 115 may comprise a mobile or handheld computing device, in which case, instead of PC-based computer peripherals like keyboard 716 and mouse 718 forming part of the user interface 117, client computing device 115 may comprise a touch-based user interface 117, such as is used in some mobile or handheld computing devices.

In some embodiments, servers associated with or comprised in CAS 110, ERP vendor 120, intermediate vendor 130, transaction tracking and notification system 140, as well as the computing device 115, may comprise standard computer systems, such as an Intel IA-32 based computer systems, and the described ERP-related software processes may be implemented as programming instructions of software modules stored on computer-readable non-volatile (e.g., hard disk, solid-state drive, flash memory, and/or optical disk) storage associated with such computer systems. However, at least one or more portions, and possibly the entirety, of the software processes could alternatively be implemented in the form of one or more dedicated hardware components, such as application-specific integrated circuits (ASICs) and/or field-programmable gate arrays (FPGAs), for example.

The data repository 162, satellite image data 164 and ERP database 166 are all accessible to CAS 110. Consumer account data 162 may be comprised in a database local to CAS 110 and may be sufficiently secure as to only allow access to the consumer account data by authenticated entities, such as CAS 110. Satellite image database 164 may be local to CAS 110 or remote therefrom. In some embodiments, satellite image database 164 may be managed and made available by a third party service provider and the image data may be accessible over a public network, such as the Internet, for example. ERP database 166 may be local to CAS 110 and securely maintained in a similar manner to consumer account data 162 so as to be accessible only to authorised entities. Consumer account data 162 and ERP database 166 are managed and updated by CAS 110, whereas satellite image database 164 may only be readable by CAS 110.

Consumer account data 162 and ERP database 166 may be located in separate physical or virtual data repositories or may be co-located. Consumer account data 162 and ERP database 166 may be distributed or discrete data repositories.

ERP vendor 120 and/or intermediate vendor 130 may comprise servers operated by or associated with an entity that is in the business of marketing and/or selling ERPs, whether as stand-alone products or packaged for sale with other products. For example, products or services that may have a net detrimental environmental impact, such as flying on a plane, may have an ERP packaged for sale with the plane ticket so as to at least partially offset the negative environmental impact of the plane flight. Although the ERP vendor 120 or intermediate vendor 130 may be (or be associated with) a business having normal business information technology infrastructure, such as computer systems, databases and service systems, for convenient reference, ERP vendor 120 and intermediate vendor 130 will be referred to herein in terms of their information technology capabilities and functions as a generator and/or processor of data and/or communications within system 100. Multiple ERP vendors 120 and/or intermediate vendors 130 may be comprised in system 100 and in communication with CAS 110.

ERP vendor 120 communicates with CAS 110 to facilitate division of a bulk resource into separate ERPs and to obtain a unique transaction code for each tracked ERP transaction. ERP vendor 120 may communicate with CAS 110 over a network, such as network 112, which may be a public network, using a secure communications protocol. ERP vendor 120 may also communicate with transaction tracking and notification system 140 over a network, such as a public network, using a suitably secure communication protocol.

If intermediate vendor 130 is involved in a purchase transaction, for example at the point of sale or by facilitation of the transaction through a third party website or other electronic commerce facilitator, the intermediate vendor 130 may be in communication with transaction tracking and notification system 140 and/or ERP vendor 120 in order to obtain the unique transaction code for enabling the transaction to be processed. The intermediate vendor 130 may also be responsible for capturing contact details of the ERP purchaser, where applicable, or providing information to the ERP purchaser to enable the purchaser (who may be user 150) to communicate with CAS 110 using computer system 115, for example, to verify allocation of the ERP to a specific environmental resource. Thus, intermediate vendor 130 may be in communication (not shown) with computer 115 over network 112 if the purchase transaction is conducted on-line.

The intermediate vendor 130 may interface directly with the CAS 110 in some embodiments, for example where generation of a transaction code request is performed by intermediate vendor 130 rather than ERP vendor 120. In such embodiments, the intermediate vendor 130 may act as, and perform the transaction-related functions of, ERP vendor 120. In some embodiments, CAS 110 may aggregate ERPs from two or more ERP vendors 120 and serve as an intermediate vendor 130.

Rather than going through intermediate vendor 130 to purchase an ERP, a prospective purchaser may purchase the ERP directly through ERP vendor 120, for example via an online transaction engine associated with ERP vendor 120, in which case the transaction tracking and notification system 140 may be bypassed and the ERP vendor 120 may communicate with computer system 115 over network 112 to facilitate the purchase transaction.

In some embodiments, notification of the transaction code and applicable access details (to enable the user 150 to login to CAS 110) may be provided via an electronic communication, for example via e-mail if the user's e-mail address is captured or otherwise accessible to the entity conducting the purchase transaction. Alternatively, the notification may be provided via a printed or written notification provided to the purchaser at the point of sale, via an on-screen display at a computer terminal or by conventional mail, for example.

In some embodiments, transaction tracking and notification system 140 may be comprised in ERP vendor 120 or otherwise directly associated therewith or under the control thereof.

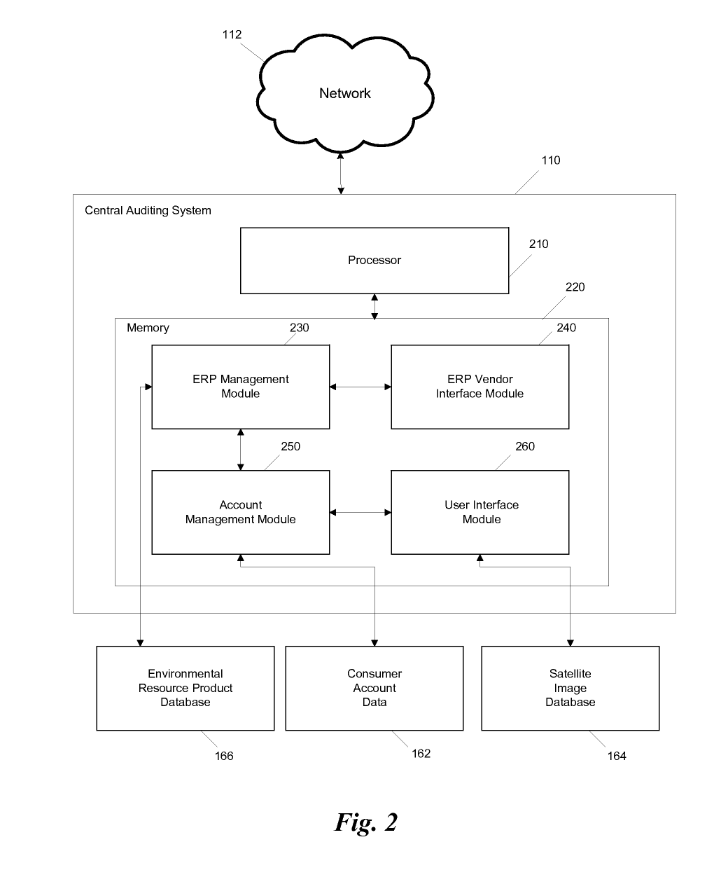

CAS 110 is responsible for providing an auditable and verifiable connection between a purchased ERP and the underlying environmental resource for which the ERP is associated. CAS 110 also provides an interface (using user interface module 260, shown in FIG. 2) accessible to a purchaser or owner of one or more ERPs to enable the purchaser or owner to check the allocation of the purchased ERP to a geographically unique location, for example by graphically overlaying the name or other identifier of the owner of the ERP onto satellite image data depicting the specific geographical location. As part of this function, CAS 110 maintains and updates consumer account data 162 to enable the mapping of ERPs owned by a specific entity onto the publicly accessible geographic information. The CAS 110 can also act as the creator of each ERP as a distinct saleable thing divided from a bulk resource sought to be sold by ERP vendor 120.

In some embodiments, division of a bulk resource into ERPs may be performed by the ERP vendor 120 in co-operation with CAS 110. In such embodiments, the ERP vendor 120 may request a list of unique ERP identifiers from CAS 110, which the ERP vendor 120 then assigns to each ERP and provides full and complete information on each newly created ERP to CAS 110 for validation etc. To the extent that any of the newly created ERPs is not successfully validated, CAS 110 communicates this to ERP vendor 120 and will not generate a unique transaction code for any transaction code request that references the unique identifier of any unsuccessfully validated ERP.

Referring now to FIG. 2, CAS 110 is described in further detail, with reference to specific program code modules executed by or within CAS 110. CAS 110 comprises a processor 210 and a memory 220. Processor 210 may comprise a single processing device or multiple processing devices, either within a single computing system or distributed across multiple computing systems. Processor 210 has access to memory 220.

Memory 220 may be partly or wholly physically located within or associated with the central auditing system 110 or maybe partly or wholly associated with or distributed across multiple computing systems that may be physically distinct from computing systems in which processor 210 is partly or wholly located. Memory 220 may comprise different forms of computer readable storage, at least some of which comprises a non-volatile store for storing program code, including the program code modules described herein.

Program code modules comprised in memory 220 include an ERP management module 230, an ERP vendor interface module 240, an account management module 250 and a user interface module 260.

ERP management module 230 is responsible for writing to and reading from ERP database 166. ERP management module 230 may write to ERP database 166 as part of the creation of one or more new ERPs or when ownership data for an ERP is updated, for example in response to the ERP being the subject of a purchase transaction. The ERP management module 230 may read from ERP database 166 to display ownership data for one or more ERPs in relation to a specific geographical location, for example when graphically overlaying the name of the owner of an ERP on satellite image data showing the environmental resource to which the ERP relates.

ERP management module 230 may also interact with ERP vendor interface module 240 to obtain information regarding a bulk resource to be divided into ERPs, and when a request is received for a unique transaction code as part of an ERP purchase transaction.

The ERP management module 230 may interact with account management module 250 when creating or updating new consumer accounts in respect of purchased ERPs. Thus, when an ERP is purchased, as the new owner of the ERP is not yet known to CAS 110 (and may not be the same entity as the purchaser), ERP management module 230 initially updates ERP database 166 to show a new owner for a respective purchased ERP, where the new owner may be initially identified by a unique numeric identifier.

Once the purchaser or owner of the ERP logs into the CAS 110 and provides the unique transaction code in order to (effectively) claim ownership of the one or more ERPs that are the subject of the purchase transaction, the owner can choose to have the owner's name and/or other information (i.e. a memorial statement to honour a deceased friend or relative) shown (e.g. in a pop-up overlay on the satellite image data), instead of the numeric identifier.

For first-time ERP purchasers, a new consumer account may be created in consumer account data 162 by account management module 250. For ERP purchasers having an existing consumer account, the unique transaction code can be used to confirm ownership of the one or more ERPs and add these to an existing portfolio of ERPs associated with the consumer account.

ERP vendor interface module 240 is responsible for communicating with ERP vendor 120 to receive requests to divide bulk resources into ERPs and to receive requests for unique transaction codes for each ERP purchase transaction. ERP vendor interface module 240 parses the requests received from ERP vendor 120 to determine whether it is validly made and, depending on the validity of the request, generates an appropriate reply to ERP vendor 120. ERP vendor interface module 240 may determine that a request from an ERP vendor 120 is not valid where, for example, geographic co-ordinates of a bulk resource submitted by an ERP vendor 120 for division overlap with the geographic co-ordinates of another bulk resource already submitted for division by the same or another ERP vendor 120 or where a transaction code request specifies unique identifiers of ERPs that have already been the subject of an ERP purchase transaction. These validity determinations may be made by ERP vendor interface module 240 by comparing data in the request received from ERP vendor 120 with data stored in the ERP database 166.

User interface module 260 is responsible for facilitating interaction with user interface 117 of computer system 115. User interface module 260 may comprise, for example, a web-based interface to allow user 150 to access the consumer account data 162 and view the specific geographic locations of their ERPs, as well as those of other ERP owners if desired, as superimposed on satellite image data obtained by user interface module 260 from satellite image database 164. As the ownership of each ERP is displayed in relation to a satellite image of the geographic area of the environmental resource based on which the ERP was generated and with which the ERP is associated, this provides for a publicly verifiable allocation of each ERP to the associated underlying environmental resource.

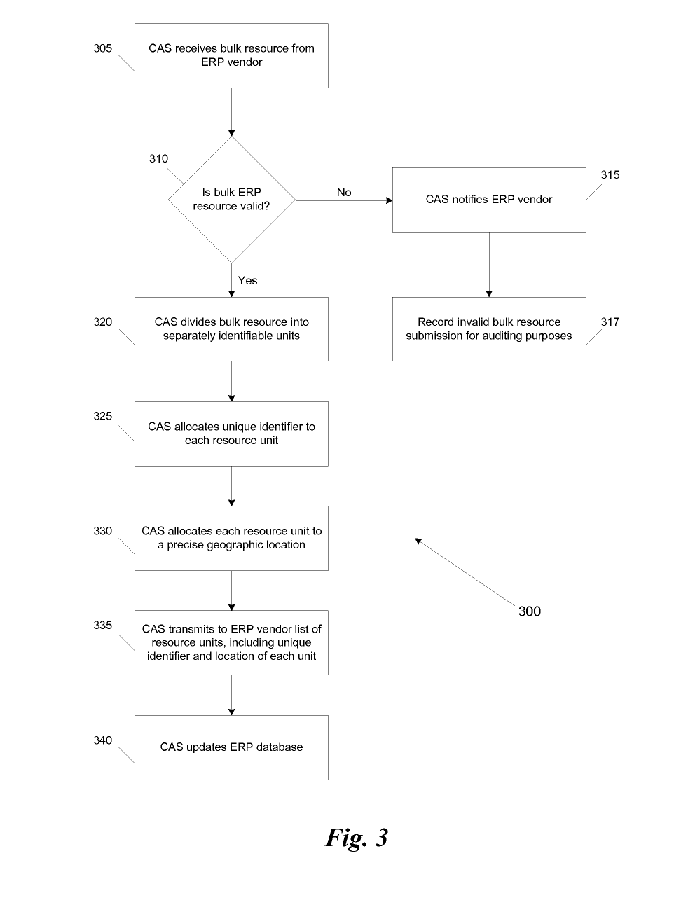

Referring now to FIG. 3, a method 300 of generating environmental resource products from a bulk environmental resource is described in further detail. For example, the ERP vendor 120 may own land that has been cleared and can be reforested or may own reforestation rights in land owned by another party. Thus, the ERP vendor 120 may offer for sale ERPs relating to reforestation of the land and may therefore submit to CAS 110 a bulk resource of, say, 100,000 sq meters for division into smaller units of, say, 10 sq metres each.

The ERPs may then be packaged as a contractual promise by the ERP vendor 120 to treat or maintain the underlying environmental resource in a particular manner. For example, the contractual promise may be to cause a 10 sq meter area of land associated with an ERP to be reforested, either permanently or for a predetermined time period, such as 50 years, for example. With the current high resolution of satellite image data available, many purchasers of ERPs relating to reforestation may be able to visually verify the fulfilment of the contractual promise. For example, fulfilment of a promise to reforest the land may be verified by inspection of the satellite image of the relevant area.

Method 300 begins at 305, at which CAS 110 receives a request from ERP vendor 120 to divide a bulk resource into one or more ERPs. In such a request, ERP vendor 120 specifies the particular type of bulk resource, for example such as land, a non-land resource or a renewable energy generation resource, and specifies the number of ERPs to be generated from the bulk resource. As part of the request for division, ERP vendor 120 must also supply exact geographic co-ordinates (in latitude and longitude) or other unique geographic location identification information of the bulk resource and may optionally include some substantiating evidence of the ERP vendor's claimed rights in the bulk resource. The ERP vendor 120 must also provide with the division request an indication of the nature of the rights held by the ERP vendor 120 in relation to the bulk resource. The division request is received by ERP vendor interface module 240, which performs an initial check to determine that the request has the required format and/or content. ERP vendor interface module 240 may provide a secure web-based interface for capturing the division request from the ERP vendor 120.

At 310, ERP vendor interface module 240 checks whether the request for division of the bulk ERP resource is valid. The request for division may not be valid if it is in an incorrect format or does not contain some of the requisite information. The request for division may also be determined to be invalid if the geographical location of the bulk resource partially or wholly overlaps the geographic location of another bulk resource from which ERPs have already been generated, for example. Optionally, if CAS 110 has access to public information concerning ownership of the bulk resource, for example such as publicly accessible land title information, ERP vendor interface module 240 may compare such ownership information with the information provided in the request for division from the ERP vendor 120 in order to determine whether the ERP 120 may have the rights in the bulk resource that it purports to have.

If ERP vendor interface module 240 determines at 310 that the request for division of the bulk resource is not valid, then at 315, ERP vendor interface module 240 notifies ERP vendor 120 of the basis upon which the request was determined not to be valid. ERP vendor interface module 240 then proceeds to record in memory 220 the request for division, and the basis on which it was found not to be valid, for auditing purposes, at 317.

If at 310 the request for division of the bulk resource is determined to be valid, then at 320 the ERP vendor interface module 240 interacts with the ERP management module 230 to divide the bulk resource into separately identifiable resource units. Optionally, if the division request includes a proposed form of division, for example such as a specific plan to divide odd-shaped land areas into smaller areas of equal size, ERP management module 230 may divide the bulk resource in the manner proposed by the ERP vendor 120. At 325, ERP management module 230 allocates a unique identifier to each resource unit resulting from the division of the bulk resource at 320.

At 330, ERP management module 230 allocates each resource unit to a precise geographic location, including the latitude and longitude of the boundaries of the resource unit, if applicable. Where the bulk resource is not divisible on the basis of geographic location, for example because it relates to a quantum of renewable energy generated by a renewable power generation system, the geographic location of each such resource unit may be the same.

At 335, ERP management module 230 generates and provides to ERP vendor interface module 240 a list of ERPs corresponding to the resource units divided from the bulk resource and this list is sent to the ERP vendor 120. The list of ERPs includes a unique identifier for each ERP, as well as the geographic location of each ERP. At 340, ERP management module 230 updates the ERP database 166 to include new database entries for the newly created ERPs, with each ERP entry in the database comprising, for example: details as to the ERP vendor 120 that submitted the bulk resource from which the ERP was divided, a pointer to the stored division request for the bulk resource, the nature of rights associated with the ERP, the unique identifier allocated to the ERP at 325 and the precise geographic location of the ERPs. Acts 335 and 340 may be performed in any order or simultaneously.

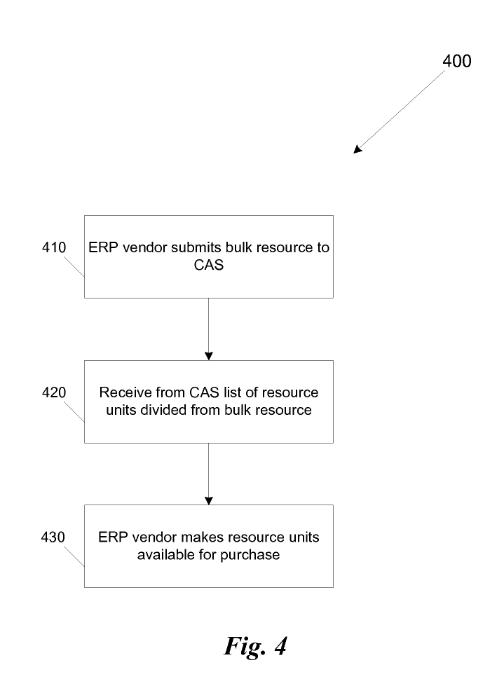

Referring now to FIG. 4, a method 400 of making environmental resource products available for purchase is described in further detail. Method 400 begins at 410, at which ERP vendor 120 submits a bulk resource to CAS 110 for division into ERPs. The information required to be submitted by ERP vendor 120 at 410 is that outlined above in relation to 305. Assuming that the request for division of the bulk resource submitted at 410 is not determined by CAS 110 to be invalid, then at 420 ERP vendor 120 receives from ERP vendor interface module 240 of CAS 110 a list of resource units (ERPs) divided from the bulk resource. The ERP list thus received is that described above in relation to 335. At 430, ERP vendor 120 then makes the newly generated ERPs available for purchase, for example by marketing ERPs on a website associated with ERP vendor 120 and/or by marketing the ERPs via intermediate vendor 130.

In alternative embodiments of method 300, division of the bulk resource into ERPs may be performed by ERP vendor 120, in cooperation with CAS 110. For example, the ERP vendor 120 may determine the precise geographic and contractual nature of each ERP to be divided from the bulk resource and may request from CAS 110 a number of unique identifiers to be allocated to the ERPs. The ERP vendor 120 then provides to CAS 110 complete information regarding each ERP divided from the bulk resource (together with an associated unique identifier and evidence to support the claimed rights in the bulk resource, if necessary) for validation by CAS 110.

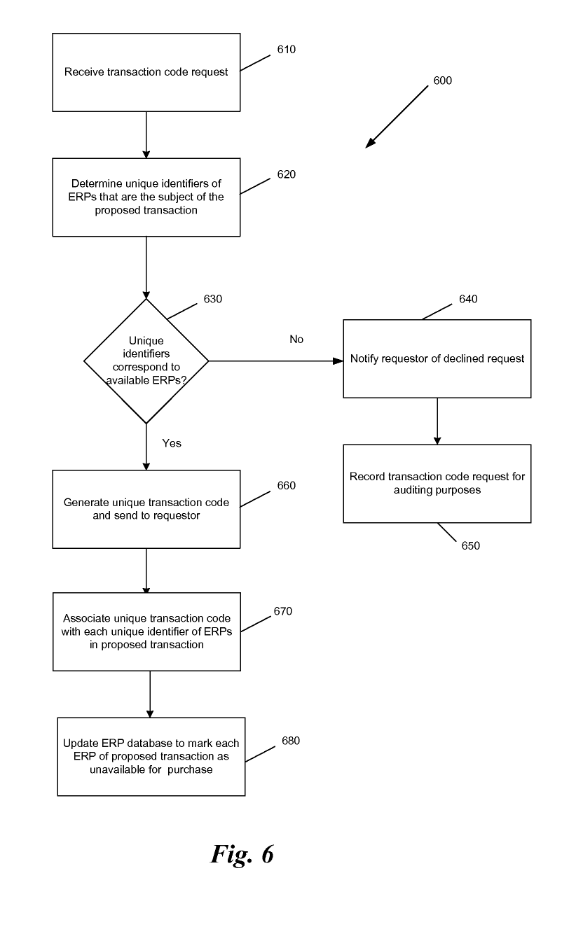

If any of the ERPs is determined by CAS 110 to not be validly created, for example due to geographical overlap with an existing ERP of the same kind, CAS 110 notifies ERP vendor 120 of the unsuccessful validation of the relevant ERPs and the reason for the validation failure. CAS 110 may record the validation failure for auditing purposes. CAS 110 then records the unique identifier for each such ERP failing validation as being invalid or inactive, such that any subsequent transaction code request specifying such an invalid unique identifier will be rejected (i.e. the transaction code request will not be successfully validated according to the method 600 described below in relation to FIG. 6). For ERPs that are not successfully validated, ERP vendor 120 may request a further unique identifier for resubmission of the ERP with corrected information.

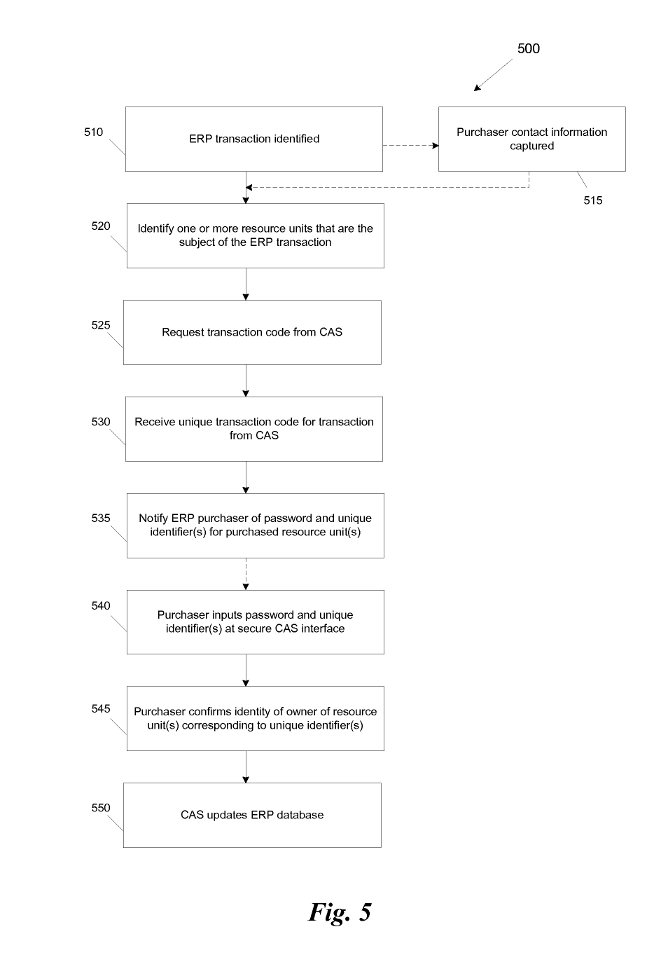

Referring now to FIG. 5, a method 500 of tracking ERP purchases is described in further detail. At 510, a purchase transaction for an ERP is identified by transaction tracking and notification system 140. The ERP transaction may be identified by notification of the occurrence of the transaction from intermediate vendor 130 or ERP vendor 120, for example. Transaction systems employed by intermediate vendor 130 and ERP vendor 120 should be configured to notify transaction tracking and notification system 140 of the purchase of the ERP as the ERP purchase transaction cannot be completed without a unique transaction code obtained from CAS 110. For example, if an intermediate vendor 130 begins processing a purchase transaction for an ERP, the intermediate vendor 130 determines a unique identifier of the ERP, for example by selecting the next available ERP identifier from a list of ERPs available for purchase.

As an optional part of the ERP purchase transaction, purchaser contact information may be captured at 515, either by manual or automatic (i.e. from a credit card) input at a point of sale at which the ERP purchase transaction is being conducted or through on-line data input fields if the ERP transaction is being conducted through an on-line electronic commerce transaction. The contact information may include, for example, an electronic mail address, a physical mail address or a contact number or an address of a messaging device or system nominated by the purchaser.

At 520, transaction tracking and notification system 140 identifies the unique identifiers of the ERPs that are the subject of the ERP purchase transaction, for example by parsing the notification provided by intermediate vendor 130 or ERP vendor 120. Act 520 may alternatively be performed by ERP vendor 120 in response to data received from transaction tracking and notification system 140 or by virtue of having facilitated the ERP purchase transaction by communicating with computer system 115.

At 525, ERP vendor 120 requests from CAS 110 a unique transaction code in order to complete the ERP purchase transaction. In the transaction code request, ERP vendor 120 provides the unique identifiers of the one or more ERPs subject to the transaction. At 530, ERP vendor receives from ERP vendor interface module 240 within CAS 110 a unique transaction code for the pending ERP purchase transaction, assuming that CAS determines the transaction code request from ERP vendor 120 to be valid. Validation of the transaction code request is described below in further detail in relation to FIG. 6. The transaction code provided by CAS 110 may optionally be accompanied by a password that the ERP purchaser can use when logging into CAS 110 to claim ownership of the ERP.

At 535, the ERP purchaser receives a purchase confirmation comprising a notification of the unique transaction code and unique identifiers of the purchased ERPs. Instead of the unique identifiers, just the unique transaction code may be provided with the notification. This notification may be provided using the contact information captured at 515, if any such contact information was captured. Alternatively, or in addition, the unique transaction code and unique identifiers of the ERPs purchased in the transaction may be notified to the ERP purchaser by the provision of a printed or displayed receipt at the point of sale or may be displayed on a web page viewable by user 150 via user interface 117 if user 150 is using computer system 115 to conduct the ERP purchase transaction. Acts 510 to 535 are performed by ERP vendor 120 in co-operation with intermediate vendor 130 and transaction tracking and notification system 140. Acts 540 to 550 (described below) are performed by CAS 110 in co-operation with computer system 115.

At 540, the ERP purchaser (or another person who has obtained the password and other purchase information from the ERP purchaser) inputs the password and the unique ERP identifiers or unique transaction code at a secure interface of CAS 110 (provided by user interface module 260) accessed using computer system 115. The purchaser or other person then confirms at 545 the identity of the owner of the ERPs corresponding to the unique identifiers. The owner may be the purchaser or the recipient of the ERP from the purchaser, for example by way of a gift. The input of the password, unique identifiers (or unique transaction code) and ownership information may be performed using standard secure or unsecure web-based interface functionality between client and server systems. As part of 545, the person claiming ownership of the one or more purchased ERPs can elect to associate (via a displayed selection or input option, for example) the purchased ERPs with an existing account, thereby merging the newly purchased ERPs into a larger portfolio of ERPs. At 550, CAS 110 updates the ERP database 166 and consumer account data 162 to include the ownership data received by CAS 110 via user interface module 260 at 545.

Referring now to FIG. 6, a method 600 of validating a transaction code request is described in further detail. At 610, the transaction code request transmitted at 525 is received at CAS 110. According to some embodiments, communications between CAS 110 and ERP vendor 120 are performed using a secure communications protocol that allows authentication of the transaction code request as being received from a trusted ERP vendor. Thus, as part of 610, CAS 110 may authenticate the transaction code request.

At 620, ERP vendor interface module 240 determines from the transaction code request one or more unique identifiers for the one or more ERPs that are the subject of the proposed ERP purchase transaction. At 630, ERP vendor interface module 240 interacts with ERP management module 230 to determine from ERP database 166 whether the unique identifiers determined at 620 are valid and correspond to ERPs that are available for purchase. The status of being available for purchase is set when the ERPs are first created from the bulk resources. According to some embodiments, an ERP may again be made available for purchase by the new owner, for example where a person or organisation owns a portfolio of ERPs and elects to sell some of those ERPs. Once a purchase transaction is effected in relation to an ERP, the ERP is recorded in the ERP database 166 as no longer being available for purchase. However, according to some embodiments, other kinds of ERPs may be created in relation to the same underlying environmental resource. For example, if an ERP comprising a conservation easement is created over a designated area of land, a similar conservation easement cannot overlap the same area of land. However, an ERP comprising a reforestation right could be created that overlaps the same area of land as the conservation easement. Thus, according to some embodiments, ERPs of different kinds may be created in respect of the same underlying environmental resource.

If at 630, any of the unique identifiers is determined at 620 to be invalid or to not correspond with available ERPs, the ERP vendor 120 from which the transaction code request was received at 610 is notified of the declined request at 640 and the declined transaction code request is recorded in ERP database 166 for auditing purposes at 650. Each received transaction code request may be recorded in ERP database 166 for auditing purposes, whether declined or accepted.

If the unique identifiers determined at 620 are valid and correspond to ERPs that are available for purchase, then at 660 a unique transaction code is generated and sent to the requesting ERP vendor 120. The unique transaction code may be randomly generated and may be numeric or alpha-numeric or may comprise ASCII characters, for example. Transmission of the unique transaction code to ERP vendor 120 from CAS 110 is handled by ERP vendor interface module 240 and may be performed using a secure communications protocol, as described above. The generation of the unique transaction code may be performed by ERP management module 230 and/or ERP vendor interface module 240 using an existing random number (or other unique identifier) generation algorithm.

At 670, the unique transaction code generated at 660 is associated with each unique identifier of the ERPs in the proposed ERP purchase transaction by updating the record for each ERP in the ERP database 166 to reference the unique transaction code. At 680, the ERP database 166 is also updated to mark each ERP of the ERP purchase transaction as being unavailable for purchase.

As CAS 110 provides the main interface by which user 150 can claim ownership and verify ownership of ERPs, CAS 110 may also provide further user interface features to enrich the user's experience in dealing with CAS 110 and purchasing the ERPs. For example, CAS 110 may provide calculators and comparators, for example to enable comparison of the cost and environmental effectiveness of different ERPs. As CAS 110 enables users to effectively develop a portfolio of ERPs associated with a single user account, CAS 110 may also combine the user's ERP portfolio data with a lifestyle environmental impact calculator and carbon-offset calculator for use in calculating the user's net environmental impact on the planet. Additionally, CAS 110 may provide a public or private ranking of ERP portfolios of different users and/or owners as a means of highlighting those that purchase numerous or significant ERPs.

CAS 110 may provide a searching interface for the purpose of allowing users to view the ERP portfolios of others. An indication of the ERPs recorded as being owned by a specific entity can then be overlaid or otherwise represented on a representation, such as a map or satellite image, of the geographical areas in which the ERPs are physically located. Additionally, a location of the entity can be shown on the map or satellite image and one or more visual associations between the location of the entity and the locations of ERPs can be depicted on the map or satellite image. For example, a company may have a large portfolio of ERPs associated with its user account and the portfolio may be set according to user-specified privacy settings to be publicly viewable. On a map or satellite image of the world, the location of the company (i.e. its head office address) may be indicated and linked, for example by coloured lines, to the locations of each of its ERPs around the world.

CAS 110 may also offer (for free or for a fee) a form of title insurance to be obtained in relation to one or more ERPs. Such title insurance may involve a guarantee that the ERP purchaser or recorded owner will be compensated if an ERP proves not to be legitimate or validly sold.

Some embodiments are directed to methods performed by CAS 110, while other embodiments are directed to methods performed by the ERP vendor 120 or intermediate vendor 130. Still further embodiments are directed to methods performed by an entity, such as a retailer of goods or services, that engages with an intermediate vendor 130 or ERP vendor 120 to offer for sale an ERP, either alone or as an adjunct to a product or service offered by the retailer in the course of its business. For example, an airline may offer plane tickets for sale through a website that it governs or is associated with. As air travel has a net detrimental environmental effect, the airline may offer an ERP for purchase together with the plane ticket, so that the purchaser can feel that they are balancing out the detrimental environmental effect that they contribute to by their mode of travel.

In such embodiments, a web page that offers an ERP in conjunction with another product (or on its own) may, in response to a purchase request (e.g. via client computing device 115) for one or more ERPs, cause (or request) a transaction code request to be transmitted to CAS 110 by an ERP vendor 120 or intermediate vendor 130. If the transaction code request is successful, then the server that received the purchase request (and caused a transaction code request to be sent to CAS 110) receives a unique transaction code generated by CAS 110 and either transmitted directly therefrom or transmitted via the ERP vendor 120 or intermediate vendor 130. The unique transaction code is received at the retailer's server along with an ERP identifier for each ERP that is the subject of the purchase request. The unique transaction code and the ERP identifier can then be used by the ERP purchaser or another party to verify the allocation of the ERP to the environmental resource using CAS 110. In notifying the purchaser of the unique transaction code and the one or more ERP identifiers, the server may provide a link or linking information to a website that displays purchased ERPs, such as may be provided via CAS 110.

Modifications of the described embodiments may be apparent to those skilled in the art, without departing from the spirit and scope of the described embodiments. The described embodiments are therefore intended to be exemplary and non-limiting when considered in the context of the appended claims.

The claims defining the invention are as follows:

1. A method for verifiable allocation of an environmental resource product (ERP) to an environmental resource, comprising:
receiving at a central server a transaction code request from an ERP vendor, the transaction code request specifying at least one ERP identifier of a respective at least one ERP that is the subject of a purchase transaction, the central server having access to public data regarding the environmental resource;
determining whether the transaction code request is valid;
generating a unique transaction code in response to the transaction code request if the transaction code request is determined to be valid;
recording the purchase of the at least one ERP; and
making publicly accessible a representation of the environmental resource having purchase status information corresponding to the purchased at least one ERP viewable in relation to the representation.

2. The method of claim 1, wherein the representation comprises rendered geographical image data of a geographical location of the environmental resource.

3. The method of claim 1, wherein the geographical image data comprises satellite image data.

4. The method of claim 1, wherein the purchase status information comprises ownership information of at least one ERP.

5. The method of claim 4, wherein the purchase status information is graphically overlaid on the representation when the representation is viewed.

6. The method of claim 1, wherein the public data comprises public geographical data and wherein the representation is based at least in part on the public data.

7. The method of claim 1, wherein the recording comprises associating the unique transaction code with a data record of each at least one ERP in a data store accessible to the central server.

8. The method of claim 1, wherein the determining comprises determining whether the at least one ERP is available for purchase based on the purchase status information.

9. The method of claim 1, further comprising providing an interface accessible through a public network, the interface allowing input of the unique transaction code or a secondary code based on the unique transaction code, wherein in response to the input of the unique transaction code or the secondary code, the interface allows input of ownership information to be viewable in relation to the purchased at least one ERP.

10. The method of claim 9, further comprising allowing searching, via the interface, of the ownership information to identify ERPs recorded as being owned by specific entities.

11. The method of claim 9, further comprising allowing displaying, via the interface, of at least one ERP recorded as being owned by a selected entity in relation to a representation of a geographical area in which the at least one ERP is located.

12. The method of claim 11, wherein the displaying further comprises displaying a location of the selected entity in relation to the representation of the geographical area and displaying a visual association between the location of the at least one ERP and the location of the selected entity.

13. The method of claim 9, further comprising allowing, via the interface, ownership information for the purchased at least one ERP to be linked to ownership information of at least one previously purchased ERP, thereby facilitating multiple ERPs purchased over time as an ERP portfolio to be recorded as being owned by a single entity.

14. A method for verifiable allocation of an environmental resource product (ERP) to an environmental resource, comprising:
identifying a purchase transaction for at least one ERP;
determining at least one unique ERP identifier for the respective at least one ERP;
transmitting a transaction code request for processing by a central server, the transaction code request specifying at least one ERP identifier, the central server having access to public data regarding the environmental resource;
receiving a unique transaction code in response to the transaction code request; and
providing notification of the unique transaction code and the at least one ERP identifier, the unique transaction code and the at least one ERP identifier being usable by a purchaser of the at least one ERP to verify at the central server the allocation of the at least one ERP to the environmental resource.

15. The method of claim 14, wherein the transmitting and receiving are performed using a secure communication protocol.

16. The method of claim 14, wherein the method is performed by a vendor of the at least one ERP.

17. The method of claim 16, wherein the vendor is the owner of the at least one ERP.

18. The method of claim 16, wherein the vendor is a re-seller of the at least one ERP.

19. The method of claims 14, wherein the notification comprises electronic notification.

20. The method of claim 14, wherein the notification comprises a printed notification.

21. The method of claim 14, wherein the environmental resource and the at least one ERP each have specific geographical locations.

22. A method comprising:
offering for sale at least one environmental resource product (ERP) corresponding to an environmental resource;
receiving a request to purchase the at least one ERP;
initiating transmission of a transaction code request for processing by a server having access to public data regarding the environmental resource;
receiving a unique transaction code generated in response to the transaction code request; and
providing notification of the unique transaction code and an ERP identifier for each at least one ERP, the unique transaction code and the at least one ERP identifier being usable to verify at the server the allocation of the at least one ERP to the environmental resource.

23. The method of claim 22, wherein the offering comprises offering the at least one ERP for sale in conjunction with an environmentally detrimental product or service.

24. The method of claim 22, wherein the server is a first server and the request is received at a second server from a client device over a network.

25. The method of claim 24, wherein the unique transaction code is generated by the first server.

26. The method of any one of claim 22, wherein the notification comprises providing a link to a website that displays purchased ERPs.

27. The method of claim 26, wherein the purchased ERPs are viewable on the website in relation to a representation of the environmental resource.

28. The method of claim 27, wherein the representation comprises a representation of a geographical area within which the environmental resource is located.

29. The method of claim 22, wherein the offering is performed using a website.

30. A method for generating environmental resource products (ERPs) based on a specific geographically located environmental resource, the method comprising:
receiving a request to divide a bulk resource corresponding to the environmental resource into at least one ERP;
validating the request;
dividing the bulk resource into at least one distinct resource unit;
allocating a unique identifier and a geographic location to each at least one resource unit; and
transmitting a list of at least one ERP in response to the request, the at least one ERP corresponding to the respective at least one resource unit, the list comprising for each at least one ERP the unique identifier allocated to each at least one resource unit.

31. Computer readable storage medium storing program code which, when executed by at least one processing device, causes the at least one processing device to provide a verifiable allocation of an environmental resource product (ERP) to an environmental resource, by:
receiving at a central server a transaction code request from an ERP vendor, the transaction code request specifying at least one ERP identifier of a respective at least one ERP that is the subject of a purchase transaction, the central server having access to public data regarding the environmental resource;
determining whether the transaction code request is valid;
generating a unique transaction code in response to the transaction code request if the transaction code request is determined to be valid;
recording the purchase of the at least one ERP; and
making publicly accessible a representation of the environmental resource having purchase status information corresponding to the purchased at least one ERP viewable in relation to the representation.

32. A system for verifiable allocation of an environmental resource product (ERP) to an environmental resource, the system comprising:
at least one processing device having access to public data relating to the environmental resource and having access to an ERP database; and
computer readable storage storing program code accessible to the at least one processor, wherein when the program code is executed by the at least one processor, the at least one processor is caused to:
receive a transaction code request from an ERP vendor, the transaction code request specifying at least one ERP identifier of a respective at least one ERP that is the subject of a purchase transaction;
determine whether the transaction code request is valid;
generate a unique transaction code in response to the transaction code request if the transaction code request is determined to be valid;
record the purchase of the at least one ERP in the ERP database; and
make publicly accessible a representation of the environmental resource having purchase status information viewable in relation to the representation, the purchase status information corresponding to the purchased at least one ERP.

33. The system of claim 32, further comprising an interface accessible through a public network and responsive to the at least one processing device, the interface allowing input of the unique transaction code or a secondary code based on the unique transaction code, wherein the at least one processing device is configured to cause the interface to allow input of ownership information to be viewable in relation to the purchased at least one ERP in response to input of the unique transaction code or the secondary code.

34. A system for verifiable allocation of an environmental resource product (ERP) to an environmental resource, the system comprising:
at least one processing device having access to public data relating to the environmental resource; and
computer readable storage storing program code accessible to the at least one processor, wherein when the program code is executed by the at least one processor, the at least one processor is caused to provide a verifiable allocation of an environmental resource product (ERP) to an environmental resource, by:
identifying a purchase transaction for at least one ERP;
determining at least one unique ERP identifier for the respective at least one ERP;
transmitting a transaction code request for processing by a central server, the transaction code request specifying at least one ERP identifier, the central server having access to public data regarding the environmental resource;
receiving a unique transaction code in response to the transaction code request; and
providing notification of the unique transaction code and the at least one ERP identifier, the unique transaction code and the at least one ERP identifier being usable by a purchaser of the at least one ERP to verify at the central server the allocation of the at least one ERP to the environmental resource.
